(19) United States
(12) Patent Application Publication
(10) Pub. No.: US 2018/0266061 A1
(43) Pub. Date: Sep. 20, 2018

(54) ROAD DECELERATION STRIP GENERATION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: BING-KUN WU, Shenzhen (CN); SHUN-CHUAN YANG, New Taipei (TW)

(21) Appl. No.: 15/640,753

(22) Filed: Jul. 3, 2017

(30) Foreign Application Priority Data
Mar. 15, 2017 (CN) 201710152701.0

(51) Int. Cl. E01F 9/529; H02K 35/04; F03G 7/08

(52) U.S. Cl. CPC E01F 9/529; F03G 7/08; H02K 35/04

(57) ABSTRACT

A road deceleration strip generation device is provided to convert mechanical energy of vehicles into a sustainable electric energy. The road deceleration strip generation device includes a road deceleration strip and a power generation member positioned in the road deceleration strip. The power generation member includes a permanent magnet unit and a coil positioned in an electromagnetic field of the permanent magnet unit. The coil is coupled to the road deceleration strip. When the road deceleration strip is pressed by a vehicle, the coil is driven by the road deceleration strip to rotate to generate induced currents.

### FIELD

The subject matter relates to a road deceleration strip generation device, which can utilize the pressure generated when a vehicle runs across a road deceleration strip to generate power.

### BACKGROUND

With popularization of vehicles, traffic safety problems are more and more prominent. To ensure the safety of traffic purposes, road deceleration strips are set to slow down the vehicles.

The road deceleration strip is also called slowdown ridge. The road deceleration strip is a traffic facility which installed on the road to make the vehicle slowdown. A shape of the road deceleration strip is generally strip, but can also be a bit like. The road deceleration strip is generally made of rubber, but can also be made of metal. The road deceleration strip is generally in black and white to cause visual attention. The road deceleration strip is slightly arched relative to the road to achieve vehicle reduction speed purpose. The road deceleration strip is generally set in the road crossing, industrial and mining enterprises, schools, residential district entrance and so on.

However, vehicles in the process of slowing down need to go through a small slope, resulting in a great energy loss. In other words, the use of road deceleration strips wastes part of the kinetic energy of the vehicles.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present charging battery unit and electronic device for microminiaturization. Moreover, in the drawing, like reference numerals designate corresponding parts throughout the whole view. Implementations of the present technology will now be described, by way of example only, with reference to the attached figures:

FIG. 1 is a module diagram of a road deceleration strip generation device with an exemplary embodiment of the present disclosure.

FIG. 2 is a schematic view of a power generation member of the road deceleration strip generation device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

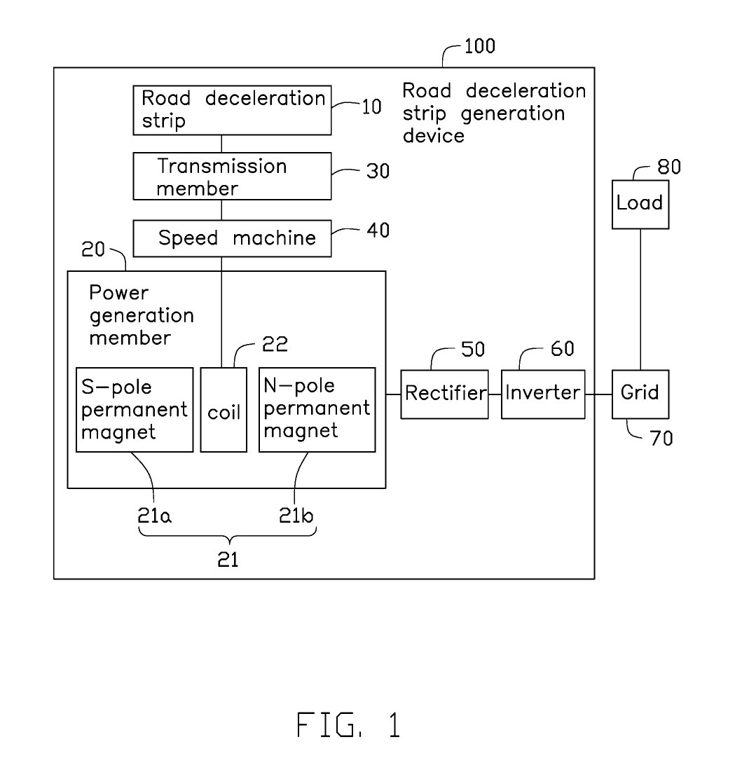

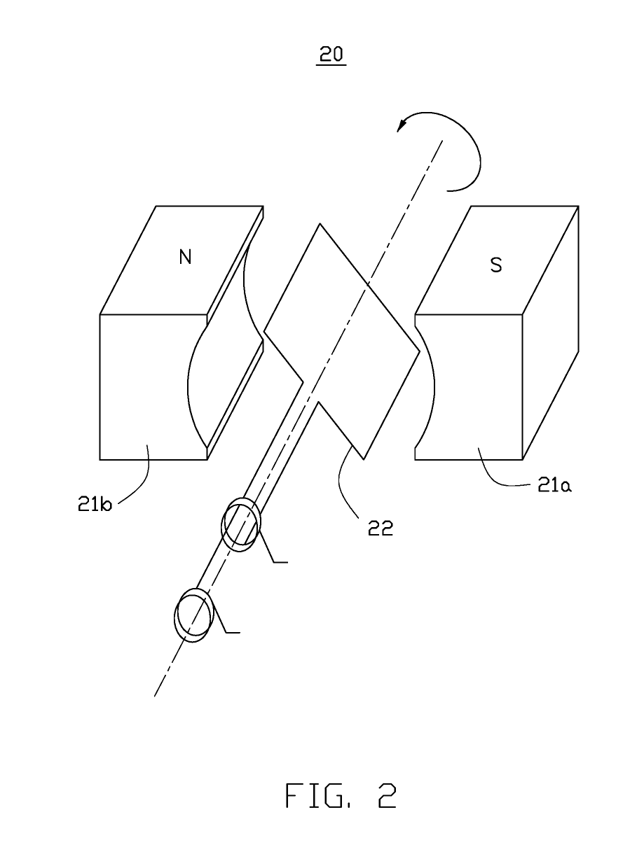

Referring to FIG. 1 and FIG. 2, the road deceleration strip generation device 100 of an exemplary embodiment of the present disclosure includes a road deceleration strip 10 and a power generation member 20 positioned in the road deceleration strip 10. When a vehicle runs across the road deceleration strip 10, the road deceleration strip 10 is pressed by the vehicle to drive the power generation member 20 to generate electrical energy. After the vehicle passes the road deceleration strip 10, the road deceleration strip 10 is returned to its original position under an elastic force of elastic members. The elastic members may be positioned between the road deceleration strip 10 and the ground.

The power generation member 20 includes a permanent magnet unit 21 and a coil 22. The coil 22 is positioned in an electromagnetic field of the permanent magnet unit 21. The permanent magnet unit 21 includes an S-pole permanent magnet 21a and an N-pole permanent magnet 21b. The S-pole permanent magnet 21a and the N-pole permanent magnet 21b face each other. The S-pole permanent magnet 21a and the N-pole permanent magnet 21b are separated from each other, and the coil 22 is located between the S-pole permanent magnet 21a and the N-pole permanent magnet 21b.

The coil 22 is coupled to the road deceleration strip 10. When the road deceleration strip 10 is pressed by the vehicle, the coil 22 is driven by the road deceleration strip 10 to rotate, so that the coil 22 cuts flux of the electromagnetic field of the permanent magnet unit 21 to generate an induced current.

Preferably, the road deceleration strip generation device 100 further includes a transmission member 30. The transmission member 30 connects the road deceleration strip 10 and the coil 22. When the road deceleration strip 10 is pressed by the vehicle, the transmission member 30 bears a pressure from the road deceleration strip 10 and converts the pressure into a torque to drive the coil 22 to rotate.

Preferably, the road deceleration strip generation device 100 further includes a speed machine 40. The speed machine 40 connects the road deceleration strip 10 and the coil 22. The speed machine 40 is configured to increase a rotational speed of the coil 22. The speed machine 40 can be a traditional gear speed increaser which has an output rotational speed greater than an input rotational speed. When the road deceleration strip 10 is pressed by the vehicle, the input rotational speed is provided by the road deceleration strip 10 to the speed machine 40, and the speed machine 40 provides the output rotational speed to the coil 22.

Preferably, the road deceleration strip generation device 100 further includes a rectifier 50 and an inverter 60. The rectifier 50 electronically connects the coil 22 and the inverter 60. The inverter 60 is electronically connected to a grid 70. The inverter 60 connects the rectifier 50 and the grid 70. The rectifier 50 and the inverter 60 feed the generated induced current to the grid 70 and further supply loads 80.

The rectifier 50 is configured to convert the alternating currents generated in the coil 22 into direct currents. The rectifier 50 further filters the direct currents to the inverter 60. The inverter 60 is configured to convert the direct currents supplied from the rectifier 50 into alternating currents with preset value, such as 220V alternating currents. The inverter 60 further feeds back the alternating currents to the grid 70 to supply the load 80. Also, the rectifier 50 and the inverter 60 may also deal with the induced currents generated in the coil 22 and then directly supply to the load 80.

An electromagnetic induction principle is utilized in the road deceleration strip generation device 100. When vehicles run across the road deceleration strip 10, the coil 22 of the power generation member 20 is rotated to generate induced currents. Thus, the mechanical energy of the vehicles is converted into a sustainable electric energy to improve the energy efficiency and save coal resources.

The embodiments shown and described above are only examples. Many details are often found in the art such as the other features of the road deceleration strip generation device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A road deceleration strip generation device, comprising:
a road deceleration strip; and
a power generation member positioned in the road deceleration strip, comprising:
a permanent magnet unit; and
a coil positioned in an electromagnetic field of the permanent magnet unit and coupled to the road deceleration strip;
wherein when the road deceleration strip is pressed by a vehicle, the coil is driven by the road deceleration strip to rotate to generate an alternating induced current.

2. The road deceleration strip generation device of claim 1, wherein the permanent magnet unit comprises an S-pole permanent magnet and an N-pole permanent magnet facing each other; and the S-pole permanent magnet and the N-pole permanent magnet are separated from each other, and the coil is located between the S-pole permanent magnet and the N-pole permanent magnet.

3. The road deceleration strip generation device of claim 1, wherein the road deceleration strip generation device further comprises a transmission member connecting the road deceleration strip and the coil and when the road deceleration strip is pressed by the vehicle, the transmission member bears a pressure from the road deceleration strip and converts the pressure into a torque to drive the coil to rotate.

4. The road deceleration strip generation device of claim 1, wherein the road deceleration strip generation device further comprises a speed machine connecting the road deceleration strip and the coil; and when the coil is driven by the road deceleration strip to rotate, the speed machine is configured to increase a rotational speed of the coil.

5. The road deceleration strip generation device of claim 1, wherein the road deceleration strip generation device further comprises a rectifier and an inverter, the rectifier electronically connects the coil and the inverter; and the rectifier is configured to convert the alternating current generated in the coil into a direct current, and further to filter the direct current to the inverter.

6. The road deceleration strip generation device of claim 5, wherein the inverter is electronically connected to a grid, and the rectifier and the inverter feed the alternating induced current to the grid and further supply loads.

7. The road deceleration strip generation device of claim 6, wherein the inverter connects the rectifier and the grid; the inverter is configured to convert the direct current supplied from the rectifier into an alternating current with preset value and further to feed back the alternating currents with preset value to the grid to supply the loads.
